(19) United States
(12) Patent Application Publication
(10) Pub. No.: US 2011/0313618 A1
(43) Pub. Date: Dec. 22, 2011

(54) ELECTRONIC CONTROL UNIT AND VEHICLE CONTROL METHOD

(75) Inventor: Jin Hwan LEE, Seongnam-si (KR)

(73) Assignee: MANDO CORPORATION

(21) Appl. No.: 13/165,328

(22) Filed: Jun. 21, 2011

(30) Foreign Application Priority Data
Jun. 22, 2010 (KR) 10-2010-0058876
May 4, 2011 (KR) 10-2011-0042294

(51) Int. Cl. G06F 7/00

(52) U.S. Cl. 701/36

(57) ABSTRACT

Disclosed is an electronic control unit capable of being mounted to any vehicle regardless of the change of a voltage level of a vehicle power system, and a method for controlling the vehicle in which the electronic control unit is mounted to the vehicle and the vehicle operates with a system driving voltage of the electronic control unit regardless of the voltage level of the vehicle power system of the vehicle.

### CROSS-REFERENCE TO RELATED APPLICATION

This application claims priority from and the benefit under 35 U.S.C. §119(a) of Korean Patent Application No. 10-2010-0058876 filed on Jun. 22, 2010 and Korean Patent Application No. 10-2011-0042294 filed on May 4, 2011, which are hereby incorporated by reference for all purposes as if fully set forth herein.

### BACKGROUND OF THE INVENTION

1. Field of the Invention

The present invention relates to an electronic control unit, which is mounted to a vehicle to control various functions of the vehicle.

2. Description of the Prior Art

As generally known in the art, the power of a vehicle using a 12V battery as a power source has reached a limit, while digitalization/multi-functionalization of recent vehicles is actively in progress to meet a high safety demand and the diversification of functions which an operator requires. Therefore, research and development for boosting an insufficient output by adding a step up function based on each unit, in order to improve efficiencies and to secure high outputs of a steering device, and an HVAC (Heating, Ventilation, and Air Conditioning) device are being progressed with the change of the vehicle power by the development of a 42V vehicle power system.

Meanwhile, eco friendly cars, such as a fuel cell electric car, a hybrid electric car, a pure electric car, etc., have been developed and the mass production of the eco friendly cars is imminent. Such eco friendly cars obtain the power by replacing a gasoline engine with a motor, and basically include a vehicle power system having a high voltage level (e.g. 200V to 400V). That is, based on the vehicle, the vehicle's power system is being changed to various types having voltage levels such as 12V, 42V, and 200V to 400V.

Meanwhile, the vehicles are required to include an electronic control unit (ECU) for controlling various kinds of functions of the vehicles such as steering, etc. At this time, the electronic control unit included in the vehicle operates with an intrinsic system driving voltage, and the system driving voltage should be the same as a voltage of the power system of the vehicle, to which the electronic control unit is mounted.

Therefore, conventional manufacturers have manufactured different electronic control units depending on voltage levels of the vehicle power systems. Accordingly, it incurs expensive design costs and manufacturing costs.

Under the recent trend in which the vehicle power systems are diversely changed, the manufacturers of the electronic control units are burdened because they should manufacture different electronic control units suitable for various vehicle power systems.

Further, when the system driving voltage of the electronic control unit to be mounted to the vehicle is different from the voltage of the vehicle power system, a separate step up device for boosting the input voltage input to the electronic control unit to the system driving voltage or a separate step down device for dropping the input voltage input to the electronic control unit to the system driving voltage is required.

### SUMMARY OF THE INVENTION

Accordingly, the present invention has been made to provide the electronic control unit capable of being mounted to any vehicle regardless of the change of a voltage level of the vehicle power system.

In accordance with an aspect of the present invention, there is provided an electronic control unit for a vehicle, including: a vehicle control system for operating with an intrinsic system driving voltage to perform a vehicle control function; and an input voltage controller for boosting or dropping an input voltage to the system driving voltage.

In accordance with another aspect of the present invention, there is provided an electronic control unit including: a comparator for comparing an input voltage input from a vehicle power system of a vehicle with a predetermined system driving voltage; a control unit for determining a step up condition to output a step up control signal when the input voltage is lower than the system driving voltage and determining a step down condition to output a step down control signal when the input voltage is higher than the system driving voltage; a voltage converting circuit unit for boosting the input voltage to the system driving voltage according the step up control signal and dropping the input voltage to the system driving voltage according the step down control signal; and a vehicle control system for performing a vehicle control function by receiving the input voltage boosted to the system driving voltage or the input voltage dropped to the system driving voltage to operate with the system driving voltage.

In accordance with another aspect of the present invention, there is provided a method for controlling a vehicle in which an electronic control unit is mounted to the vehicle and the vehicle operates with a system driving voltage of the electronic control unit regardless of a voltage level of a vehicle power system of the vehicle through a voltage conversion by the electronic control unit, the method including: receiving an input of an input voltage from the vehicle power system of the vehicle; comparing the input voltage with a predetermined system driving voltage; determining a step up condition to output a step up control signal when the input voltage is lower than the system driving voltage, and determining a step down condition to output a step down control signal when the input voltage is higher than the system driving voltage; boosting the input voltage to the system driving voltage according to the step up control signal, and dropping the input voltage to the system driving voltage according to the step down control signal; and performing a vehicle control function by receiving the input voltage boosted to the system driving voltage or the input voltage dropped to the system driving voltage to operate with the system driving voltage.

### BRIEF DESCRIPTION OF THE DRAWINGS

FIG. 1 is a block diagram of an electronic control system for a vehicle according to an embodiment of the present invention;

FIG. 2 is a block diagram illustrating a case in which the electronic control system according to an embodiment of the present invention includes a plurality of electronic control units;

FIG. 3 is a block diagram of the electronic control unit for a vehicle according to an embodiment of the present invention;

FIG. 4 is a block diagram illustrating a case in which the electronic control unit according to an embodiment of the present invention includes a plurality of vehicle control systems;

FIG. 5 is a block diagram of an input voltage control apparatus according to an embodiment of the present invention;

FIG. 6 is a block diagram of a voltage converter included in the input voltage control apparatus according to an embodiment of the present invention;

FIG. 7 is a flowchart of an input voltage control method according to an embodiment of the present invention;

FIG. 8 is a block diagram of an electronic control unit according to another embodiment of the present invention;

FIG. 9 illustrates a voltage converting circuit unit included in the electronic control unit according to another embodiment of the present;

FIGS. 10A to 10C illustrate the electronic control units mounted to vehicles having different vehicle power systems according to another embodiment of the present; and

FIG. 11 is a flowchart of a vehicle control method according to another embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

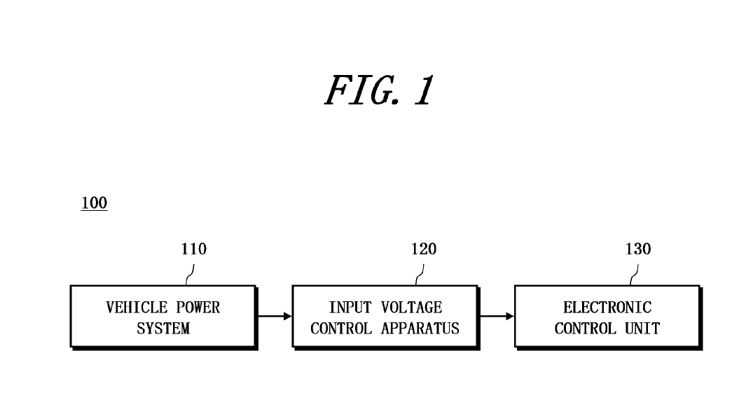

FIG. 1 is a block diagram of an electronic control system 100 for a vehicle according to an embodiment of the present invention.

As shown in FIG. 1, the electronic control system 100 for a vehicle according to an embodiment of the present invention includes an electronic control unit 130 for operating with an intrinsic system driving voltage to perform a vehicle control function, and an input voltage control apparatus 120 for boosting or dropping an input voltage input from the vehicle power system 110 to the system driving voltage of the electronic control unit 130.

Recently, the vehicles are being equipped with various kinds of control systems and devices, and the various kinds of control systems and devices require different system driving voltages. Therefore, different driving voltages should be supplied to corresponding control systems and devices or separate electronic control units for the various kinds of control systems and devices should be designed.

However, when the electronic control system 100 for a vehicle according to an embodiment of the present invention is used, the input voltage control apparatus 120 supplies the input voltage to the electronic control unit 130 after converting the input voltage to the system driving voltage, which the electronic control unit 130 desires, no matter what size of the input voltage is supplied from the vehicle power system 110. Therefore, the electronic control unit 130 can be supplied with the system driving voltage, which the electronic control unit 130 desires, regardless of the size of the input voltage supplied by the vehicle power system 110. Accordingly, there is an advantage in that the design and the development of the electronic control unit 130 can be implemented regardless of the vehicle power system.

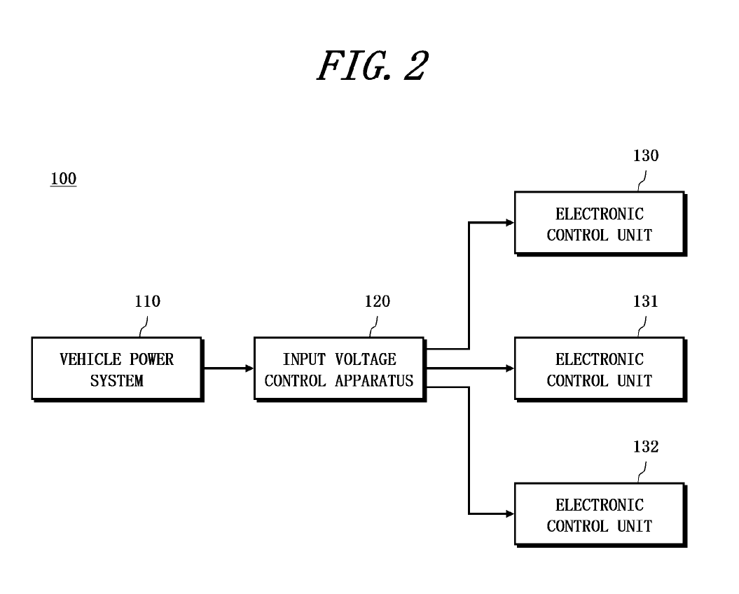

Although FIG. 1 illustrates one electronic control unit supplied with the input voltage converted by the input voltage control apparatus 120, the input voltage control apparatus 120 can supply the converted input voltage to a plurality of electronic control units as occasion demands. A case, in which the input voltage control apparatus 120 supplies the converted input voltage to the plurality of electronic control units, is illustrated in FIG. 2.

FIG. 2 is a block diagram illustrating a case in which the electronic control system according to an embodiment of the present invention includes the plurality of electronic control units.

Unlike FIG. 1, which is a block diagram of the electronic control system 100 for a vehicle including one electronic control unit 130, FIG. 2 is a block diagram of the electronic control system 100 for a vehicle further including two electronic control units 131 and 132 operating with the same system driving voltage or different system driving voltages.

In FIG. 2, the input voltage control apparatus 120 receives an input of identification information for the unit supplied with the input voltage, which is to be boosted or dropped, input from the vehicle power system 110. Then, the input voltage control apparatus 120 selects the electronic control unit 130 from among the plural electronic control units 130, 131, and 132 as the unit supplied with the input voltage, which is to be boosted or dropped, input from the vehicle power system. Subsequently, the input voltage control apparatus 120 identifies the intrinsic system driving voltage of the electronic control unit 130, boosts or drops the input voltage to the intrinsic system driving voltage, and then supplies the system driving voltage to the electronic control unit 130.

Each of the electronic control units 130, 131, and 132 included in the electronic control system 100 for a vehicle according to an embodiment of the present invention in FIGS. 1 and 2 may be an electronic control unit for one or more of various kinds of control systems and devices within a vehicle and may be identical to a conventional Electronic Control Unit (ECU).

Here, the various kinds of control systems and devices within a vehicle may include chassis control systems such as an EPS, an EMB, an ESC, etc., an air conditioning control device such an HVAC, etc., multimedia devices such as an audio system, a navigation unit, etc., and external control devices such as for a window, a wiper, etc., and may require different system driving voltages such as a 12V vehicle power system, a 42V vehicle power system, or a 200V to 300V vehicle power system (used in an electric vehicle).

According to the present invention described above, there is an effect in that a separate vehicle power system or a separate power converting apparatus for supplying different voltages is not required for the electronic control unit 130 for a vehicle requiring different vehicle power constructions.

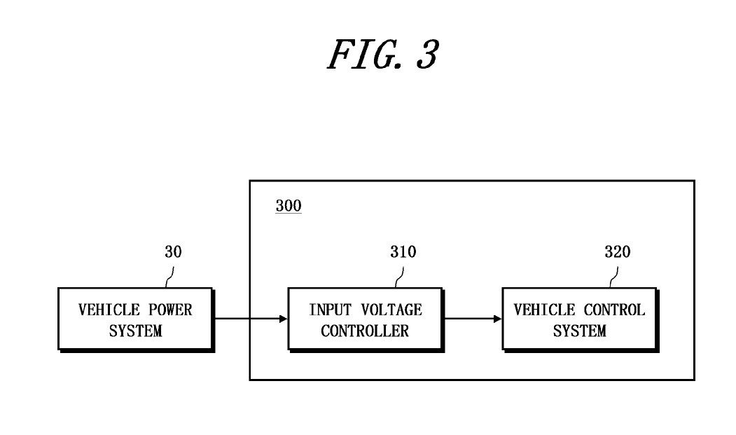

FIG. 3 is a block diagram of the electronic control unit 300 for a vehicle according to an embodiment of the present invention.

As shown in FIG. 3, the electronic control unit 300 for a vehicle according to an embodiment of the present invention is an electronic control unit having an input voltage control function in that the electronic control unit 300 for a vehicle of FIG. 3 includes an input voltage controller 310, unlike the electronic control units 130, 131, and 132 shown in FIGS. 1 and 2.

Referring to FIG. 3, the electronic control unit 300 according to an embodiment of the present invention includes a vehicle control system 320 for operating with an intrinsic system driving voltage to perform a vehicle control function, and an input voltage controller 310 for boosting or dropping the input voltage input from the vehicle power system 30 to the system driving voltage of the vehicle control system 320.

Recently, vehicles may include various kinds of control systems and devices, and the various kinds of control systems and devices require different system driving voltages. Therefore, a conventional electronic control unit for each of the various kinds of control systems and devices requires a vehicle power system for supplying different input voltages or a plurality of devices for converting input voltages of the same size to voltages of different sizes.

However, the electronic control unit 300 for a vehicle according to an embodiment of the present invention has an advantage in that the electronic control unit 300 for a vehicle does not need a converting device for changing the vehicle power system 30 of the vehicle or converting the input voltage because the electronic control unit 300 for a vehicle can operate a vehicle control by converting the input voltage to a voltage having a size, which the electronic control unit 300 for a vehicle desires, after receiving the input voltage without any change, no matter what size of input voltage the power system of the vehicle supplies.

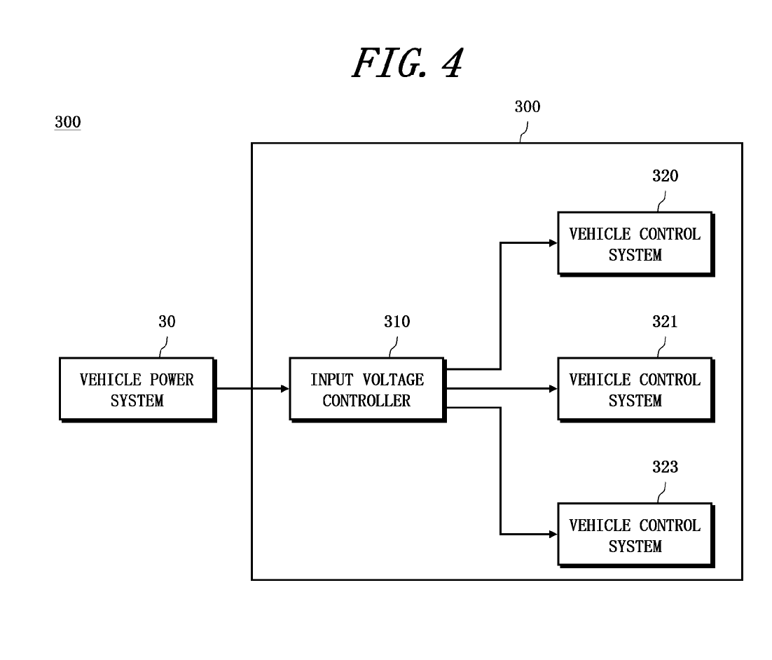

Although FIG. 3 illustrates one vehicle control system supplied with the input voltage converted by the input voltage controller 310, the input voltage controller 310 can supply the converted input voltage to a plurality of vehicle control systems in some cases. The above case will be illustrated in FIG. 4.

FIG. 4 is a block diagram illustrating the case in which the electronic control unit according to an embodiment of the present invention includes the plurality of vehicle control systems.

In comparison with FIG. 3 illustrating a block diagram of the electronic control unit 300 including one vehicle control system 320, FIG. 4 is a block diagram of the electronic control unit 300 further including two vehicle control systems 321 and 322 operating with the same system driving voltage or different system driving voltages.

In FIG. 4, the input voltage control apparatus 120 receives an input of identification information for the unit supplied with the input voltage, which is to be boosted or dropped, input from the vehicle power system 30. Then, the input voltage control apparatus 120 selects the vehicle control system 320 from among the plural vehicle control systems 320, 321, and 322 as the unit supplied with the input voltage, which is to be boosted or dropped, input from the vehicle power system 30. Subsequently, the input voltage control apparatus 120 identifies the intrinsic system driving voltage of the selected vehicle control system 320, boosts or drops the input voltage to the intrinsic system driving voltage, and then supplies the system driving voltage to the vehicle control system 320.

According to an embodiment of the present invention, the electronic control units 300 shown in FIGS. 3 and 4 may be electronic control units for one or more of various kinds of control systems and devices within a vehicle.

Here, the various kinds of control systems and devices within a vehicle may include chassis control systems such as an EPS, an EMB, an ESC, etc., an air conditioning control device such an HVAC, etc., multimedia devices such as an audio system, a navigation unit, etc., and external control devices such as for a window, a wiper, etc., and may require different system driving voltages such as a 12V vehicle power system, a 42V vehicle power system, or a 200V to 300V power system (used in an electric vehicle).

According to the present invention described above, in comparison with the conventional electronic control unit for a vehicle dependent on a construction of the vehicle power, the electronic control unit 300 according to an embodiment of the present invention independent with regard to the construction of the vehicle power can be provided.

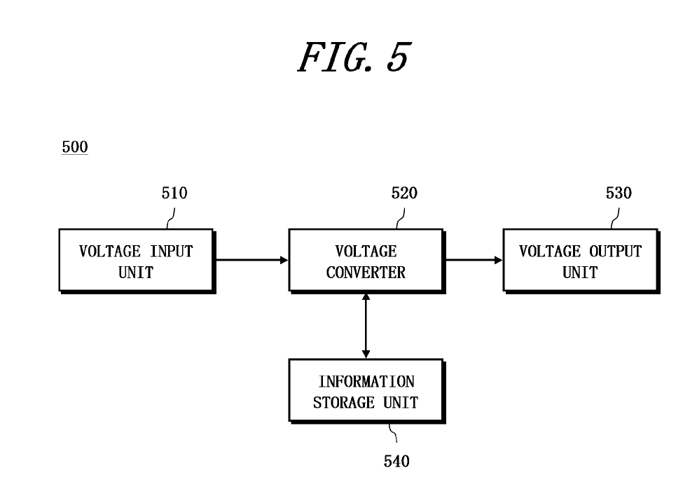

FIG. 5 is a block diagram of the input voltage control apparatus 500 according to an embodiment of the present invention.

As shown in FIG. 5, the input voltage control apparatus 500 according to an embodiment of the present invention includes an information storage unit 540 for storing system driving voltage information for each electronic control unit, a voltage input unit 510 for receiving an input of the input voltage, a voltage converter 520 for boosting or dropping the input voltage to a specific system driving voltage of a specific electronic control unit based on the system driving voltage information for each electronic control unit for one or more electronic control units, and a voltage output unit 530 for outputting the input voltage, which has been boosted or dropped to the specific system driving voltage, to the specific electronic control unit, for the electronic control unit mounted to the vehicle.

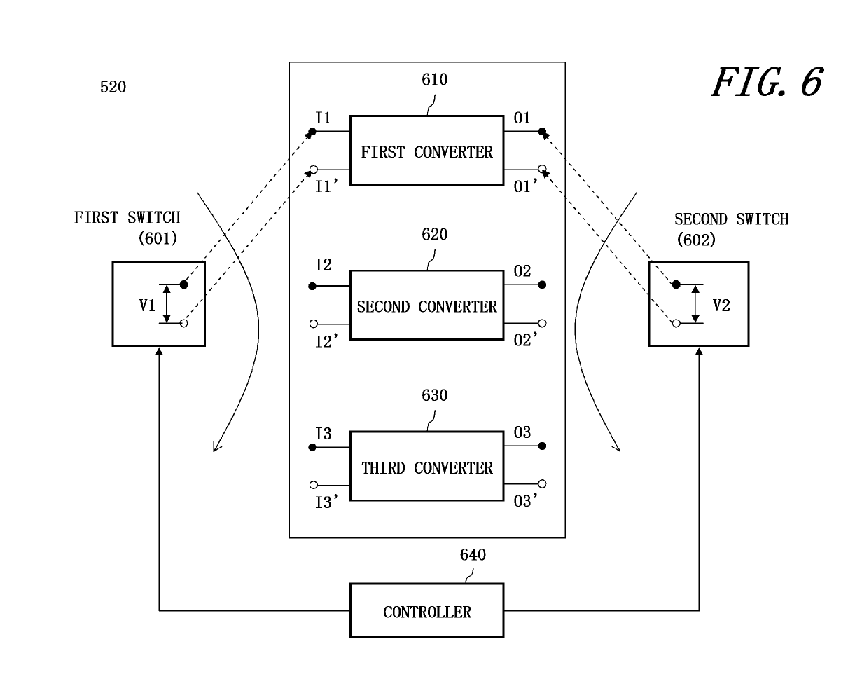

The voltage converter 520 can use various converting schemes in order to convert the input voltage of the specific electronic control unit to the specific system driving voltage. A converter switch scheme among the various converting schemes will be described with reference to FIG. 6.

FIG. 6 is a block diagram of the voltage converter 520 included in the input voltage control apparatus 500 according to an embodiment of the present invention.

FIG. 6 is a block diagram of the voltage converter 520 for converting the input voltage of the specific electronic control unit to the specific system driving voltage by using the converter among the various converting schemes for converting the input voltage of the specific electronic control unit to the specific system driving voltage.

As shown in FIG. 6, the voltage converter 520 includes two switches (a first switch 601 and a second switch 602 in FIG. 6) for selecting a plurality of converters (a first converter 610, a second converter 620, and a third converter 630 in FIG. 6) having different voltage transformation ratios or different voltage turns ratios, and a converter having a voltage transformation ratio or a voltage turns ratio, which the voltage converter 520 desires, among the plurality of converters 610, 620, and 630.

Further, as shown in FIG. 6, the voltage converter 520 further includes a controller 640 for making a control so that the two switches 601 and 602 select the converter having the voltage transformation ratio or the voltage turns ratio, which the voltage converter 520 desires, among the plurality of converters 610, 620, and 630.

The controller 640 makes a control so that the two switches 601 and 602 select one converter among the plurality of converters 610, 620, and 630, with reference to the system driving voltage information for each electronic control unit stored in the storage unit 540.

Referring to FIG. 6, a voltage conversion scheme will be described based on an assumption that the input voltage input to the voltage input unit 510 should be supplied to the specific electronic control unit having the specific system driving voltage.

Referring to FIG. 6, the voltage converter 520 searches for the specific system driving voltage of the specific electronic control unit in the system driving voltage information for each electronic control unit stored in the information storage unit 540 by using identification information of the specific electronic control unit. Then the voltage converter 520 controls the first switch 601 and the second switch 602 so that a converter (first converter 610 in FIG. 6) having a voltage transformation ratio or a voltage turns ratio corresponding to a ratio (i.e. voltage transformation ratio=specific system driving voltage/input voltage) of the specific system driving voltage for the input voltage among the first converter 610, the second converter 620, and the third converter 630 is selected, in order to convert the input voltage to the searched specific system driving voltage.

According to the control of the switches, both ends of the first switch 601, to which the input voltage V1 input to the voltage input unit 510 is applied, are connected to both ends IN1 and IN1′ of an input side (a first circuit) of the first converter 610, both ends of the second switch 602 connected to the voltage output unit 530 are connected to both ends OUT1 and OUT1′ of an output side (a second circuit) of the fist converter 610.

Accordingly, through the first converter 310, the input voltage V1 is converted (boosted or dropped) to the specific system driving voltage V2 of the specific electronic control unit, and then the specific system driving voltage V2 is transmitted to the voltage output unit 530.

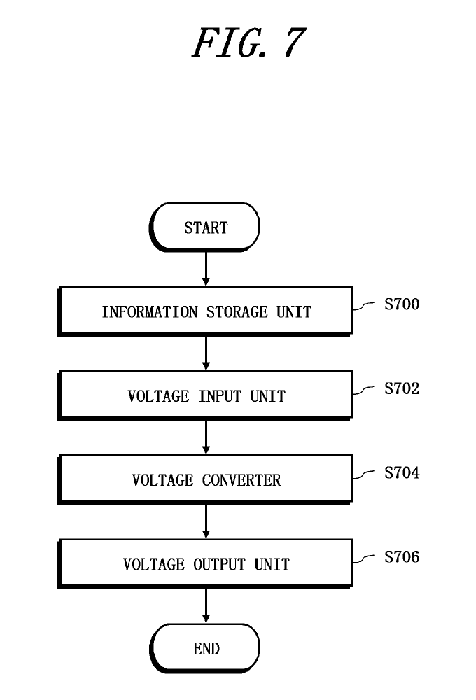

FIG. 7 is a flowchart of an input voltage control method provided by the input voltage control apparatus 500 according to an embodiment of the present invention.

Referring to FIG. 7, the input voltage control method according to an embodiment of the present invention includes storing the system driving voltage information for each electronic control unit S700, receiving an input of the input voltage S702, boosting or dropping the input voltage to the specific system driving voltage of the specific electronic control unit based on the system driving voltage information for each electronic control unit S704, and outputting the specific system driving voltage to the specific electronic control unit S706, for the electronic control unit mounted to the vehicle.

Hereinafter, the aforementioned electronic control unit 300 will be described in detail with reference to FIG. 3. Referring to FIG. 3, the electronic control unit 300 is an electronic control unit having an input voltage control function and includes the input voltage controller 310 and the vehicle control system 320.

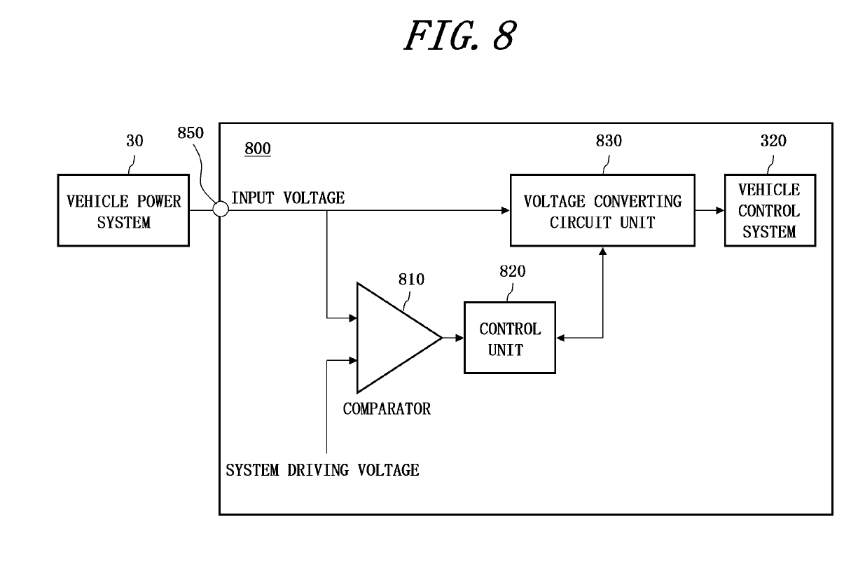

FIG. 8 is a block diagram of the electronic control unit 800 according to another embodiment of the present invention.

Referring to FIG. 8, the electronic control unit 800 according to another embodiment of the present invention includes a comparator 810 for comparing the input voltage input from the vehicle power system 30 of the vehicle with a predetermined system driving voltage, a control unit 820 for determining a step up condition to output a step up control signal when the input voltage is lower than the system driving voltage and for determining a step down condition to output a step down control signal when the input voltage is higher than the system driving voltage, a voltage converting circuit unit 830 for boosting the input voltage to the system driving voltage according to the step up control signal and dropping the input voltage to system driving voltage according to the step down control signal, and the vehicle control system 320 for performing a vehicle control function by receiving an input of the input voltage boosted to the system driving voltage or dropped to the system driving voltage to operate.

The input voltage controller 310 included in the electronic control unit 300 of FIG. 3 can be divided into the comparator 810, the control unit 820, and the voltage converting circuit unit 830 according to functions.

As described above, when the input voltage is lower than the system driving voltage, the control unit 820 determines it as the step up condition to output the step up control signal. When the input voltage is higher than the system driving voltage, the control unit 820 determines it as the step down condition to output the step down control signal. When the input voltage is the same as the system driving voltage, the control unit 820 does not output the step up control signal or the step down control signal and makes a control so that the input voltage is input to the vehicle control system 320 without any change.

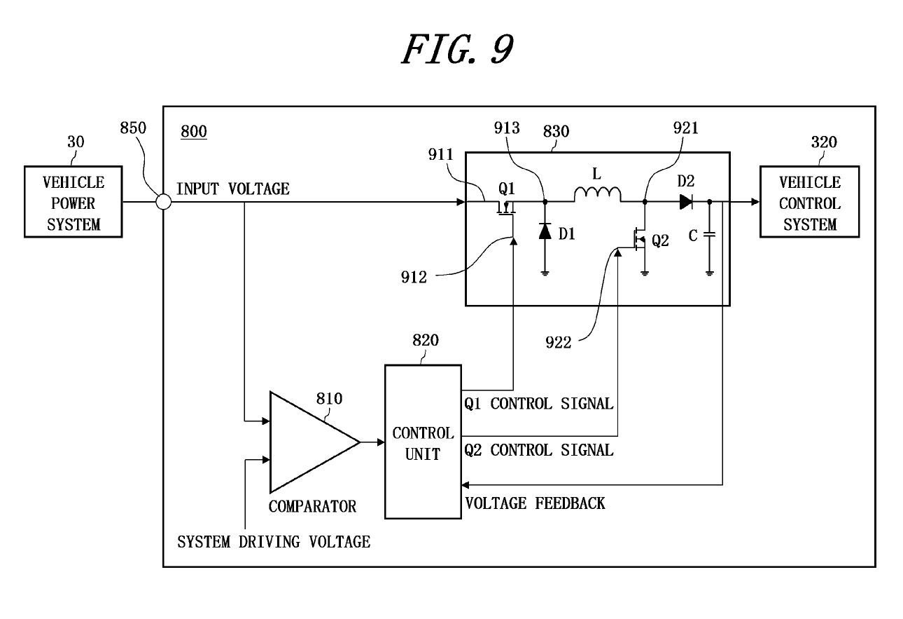

The voltage converting circuit unit 830 included in the electronic control unit 800 according to another embodiment of the present invention will be described in detail with reference to FIG. 9.

FIG. 9 illustrates the voltage converting circuit unit 830 included in the electronic control unit 800 according to another embodiment of the present invention.

Referring to FIG. 9, the voltage converting circuit unit 830 includes a chopper circuit including a first switching device Q1 connected to an input terminal 850 of the input voltage, a second switching device Q2, and an inductor L connecting an output end of the first switching device Q1 with an input end of the second switching device Q2.

Referring to FIG. 9, the chopper circuit included in the voltage converting circuit unit 830 includes an input end 911 of the first switching device Q1 connected to the input terminal 850 of the input voltage, a driving end 912 of the first switching device Q1 connected to the control unit 820, an output end 913 of the first switching device Q1 connected to an end of a cathode of a first diode D1 and an end of the inductor L, an input end 921 of the second switching device Q2 connected to another end of the inductor L and an anode of a second diode D2, a driving end 922 of the second switching device Q2 connected to the control unit 820, and a cathode of the second diode D2 connected to a condenser C and the vehicle control system.

The driving end 912 of the first switching device Q1 is connected to the control unit 820 to receive an input of a Q1 control signal. The input Q1 control signal may be the step up control signal or the step down control signal. Further, the driving end 922 of the second switching device Q2 is connected to the control unit 820 to receive an input of a Q2 control signal. The input Q2 control signal may be the step up control signal or the step down control signal.

When the input voltage is lower than the system driving voltage so that the control unit 820 determines it as the step up condition to output the step up control signal, the control unit 820 outputs the Q1 control signal as the step up control signal to the end 912 of the first switching device Q1 and outputs the Q2 control signal as the step up control signal to the end 922 of the second switching device Q2.

At this time, the Q1 control signal is a signal having a voltage value, which makes the first switching device Q1 is in a full-on state, and the Q2 control signal is a signal having a voltage value, which makes the second switching device Q2 is in a chopper control state.

By the repetition of on-off states in which the first switching device Q1 is in the full-on state according to the Q1 control signal (step up control signal) and the second switching device Q2 is in the chopper control state according to the Q2 control signal (step up control signal), a current amount flowing in the inductor L is changed and the voltage is induced, which makes the input voltage be boosted to the system driving voltage.

The control unit 820 can control a step up ratio of the input voltage by controlling an on-off repetition ratio of the second switching device Q2 through the control of the Q2 control signal (step up control signal).

When the input voltage is higher than the system driving voltage so that the control unit 820 determines it as the step down condition to output the step down control signal, the control unit 820 outputs the Q1 control signal as the step down control signal to the driving end 912 of the first switching device Q1 and outputs the Q2 control signal as the step down control signal to the driving end 922 of the second switching device Q2.

At this time, the Q1 control signal is a signal having a voltage value, which makes the first switching device Q1 is in a chopper control state, and the Q2 control signal is a signal having a voltage value, which makes the second switching device Q2 is in a full-off state.

The control unit 820 can control a step down ratio of the input voltage by controlling an on-off repetition ratio of the first switching device Q1 through the control of the Q1 control signal (step down control signal).

The aforementioned first switching device Q1 may be a P-type power semiconductor device and the aforementioned second switching device Q2 may be an N-type power semiconductor device.

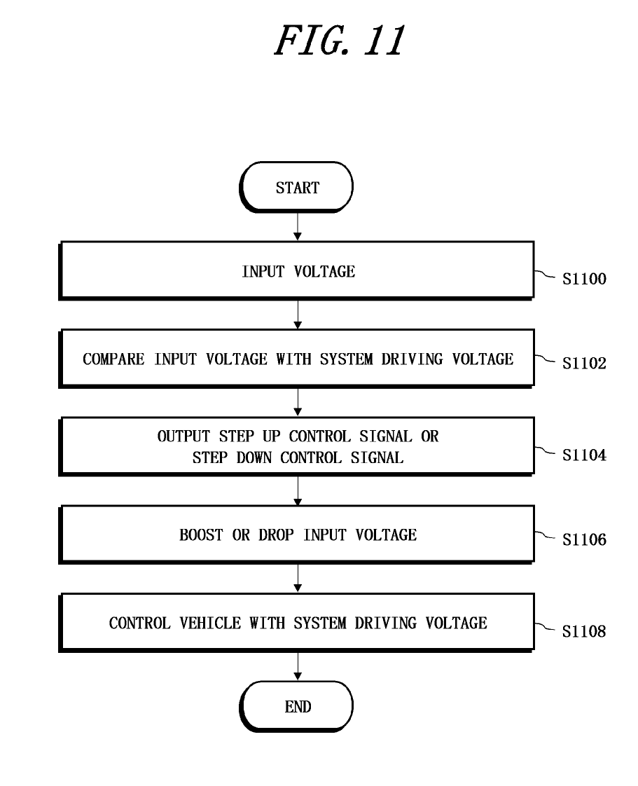

The electronic control unit 800 according to another embodiment of the present invention can be mounted to any vehicle regardless of whether the system driving voltage of the electronic control unit 800 and the voltage of the vehicle power system 30 have the same voltage level, and it will be described with reference to FIG. 11.

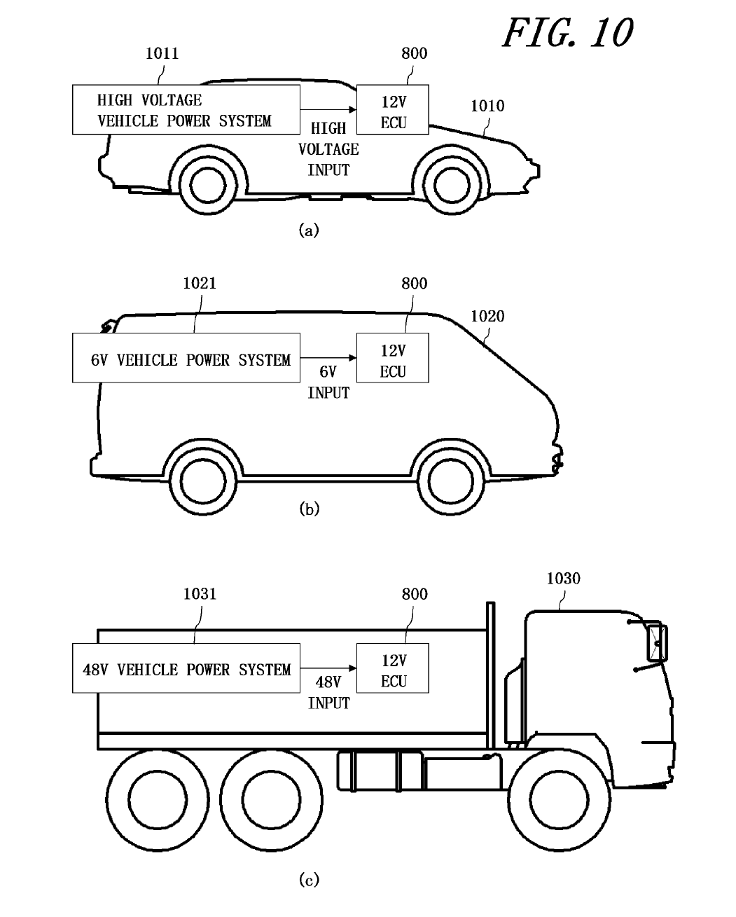

FIGS. 10A to 10C illustrate the electronic control units 800 mounted to vehicles 1010, 1020, and 1030 having different vehicle power systems 1011, 1021, and 1031 according to another embodiment of the present invention.

In FIGS. 10A to 10C, it is assumed that the vehicle control system 320 included in the electronic control unit 800 according to another embodiment of the present has a 12V system driving voltage.

FIG. 10A illustrates a case in which the electronic control unit 800 having the 12V system driving voltage is mounted to an electric vehicle 1010 including a high voltage vehicle power system 1011 outputting the input voltage having a high voltage (in a range of 200V to 400V).

Since the input voltage is higher than the system driving voltage (12V), the electronic control unit 800 can perform the vehicle control function by dropping the high input voltage to 12V, which is the system driving voltage.

FIG. 10B illustrates a case in which the electronic control unit 800 having the 12V system driving voltage is mounted to a van 1020 including a high voltage vehicle power system 1021 outputting a 6V input voltage.

Since the input voltage is lower than the system driving voltage (12V), the electronic control unit 800 can perform the vehicle control function by boosting the low input voltage to 12V, which is the system driving voltage.

FIG. 10C illustrates a case in which the electronic control unit 800 having the 12V system driving voltage is mounted to a truck 1030 including a high voltage vehicle power system 1031 outputting a 48V input voltage.

Since the input voltage is higher than the system driving voltage (12V), the electronic control unit 800 can perform the vehicle control function by dropping the high input voltage to 12V, which is the system driving voltage.

As shown in FIGS. 10A to 10C, the electronic control unit 800 can be mounted to all the vehicles 1010, 1020, and 1030 having vehicle power systems 1011, 1021, and 1031 outputting input voltages different from the system driving voltages. At this time, the electronic control unit 800 does not require a separate step up device or a separate step down device.

Therefore, manufacturers can manufacture only one kind of electronic control unit 800 regardless of a voltage level of the vehicle power system included in the vehicle, to which the electronic control unit 800 is mounted. Accordingly, design and manufacturing costs can be reduced, and the separate step up and step down devices are not required, thereby making better use of a space.

So far, the method for performing the vehicle control, in which the electronic control unit 800 according to another embodiment of the present invention is mounted to the vehicle so that the vehicle operates with the system driving voltage of the electronic control unit 800 regardless of a voltage level of the vehicle power system of the vehicle, has been described. Hereinafter, a method for controlling the vehicle, in which the electronic control unit 800 according to another embodiment of the present invention is mounted to the vehicle so that the vehicle operates with the system driving voltage of the electronic control unit 800 regardless of a voltage level of the vehicle power system 30 of the vehicle, will be described with reference to FIG. 11.

FIG. 11 is a flowchart illustrating the method for controlling the vehicle according to another embodiment of the present invention.

Referring to FIG. 11, the method for controlling the vehicle, in which the electronic control unit 800 according to another embodiment of the present invention is mounted to the vehicle so that the vehicle operates with the system driving voltage of the electronic control unit 800 regardless of a voltage level of the vehicle power system of the vehicle, includes receiving an input of the input voltage from the vehicle power system of the vehicle S1100, comparing the input voltage with a predetermined system driving voltage S1102, outputting the step up control signal when the input voltage is lower than the system driving voltage so that it is determined as the step up condition and outputting the step down control signal when the input voltage is higher than the system driving voltage so that it is determined as the step down condition S1104, boosting the input voltage to the system driving voltage according to the step up control signal and dropping the input voltage to the system driving voltage according to the step down control signal S1106, and performing a vehicle control function by operating through an input of the input voltages boosted to the system driving voltage or dropped to the system driving voltage S1108.

As described above, the present invention provides the electronic control unit capable of being mounted to any vehicle regardless of the change of the voltage level of the vehicle power system.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An electronic control unit for a vehicle, comprising:
a vehicle control system for operating with an intrinsic system driving voltage to perform a vehicle control function; and
an input voltage controller for boosting or dropping an input voltage to the system driving voltage.

2. The electronic control unit for a vehicle as claimed in claim 1, wherein the input voltage controller determines the vehicle control system as a unit to which the input voltage input from the vehicle power system is to be supplied after being boosted or dropped, identifies the intrinsic system driving voltage of the vehicle control system, and boosts or drops the input voltage to the intrinsic system driving voltage to supply the boosted or dropped input voltage to the vehicle control system.

3. An electronic control unit comprising:
a comparator for comparing an input voltage input from a vehicle power system of a vehicle with a predetermined system driving voltage;
a control unit for determining a step up condition to output a step up control signal when the input voltage is lower than the system driving voltage and determining a step down condition to output a step down control signal when the input voltage is higher than the system driving voltage;
a voltage converting circuit unit for boosting the input voltage to the system driving voltage according the step up control signal and dropping the input voltage to the system driving voltage according the step down control signal; and
a vehicle control system for performing a vehicle control function by receiving the input voltage boosted to the system driving voltage or the input voltage dropped to the system driving voltage to operate with the system driving voltage.

4. The electronic control unit as claimed in claim 3, wherein the voltage converting circuit unit comprises:
a chopper circuit comprising a first switching device connected to an input terminal of the input voltage, a second switching device, and an inductor connecting an output end of the first switching device with an input end of the second switching device,
wherein the first switching device is in a full-on state according to the step up control signal and the second switching device is in a chopper control state, so that the input voltage is boosted to the system driving voltage, and
the second switching device is in a full-off state according to the step down control signal and the first switching device is in a chopper control state, so that the input voltage is dropped to the system driving voltage.

5. The electronic control unit as claimed in claim 4, wherein the chopper circuit is configured in such a manner that the input end of the first switching device is connected to the input terminal of the input voltage, a driving end of the first switching device is connected to the control unit, the output end of the first switching device is connected to a cathode of a first diode and an end of the inductor, the input end of the second switching device is connected to another end of the inductor and an anode of a second diode, a driving end of the second switching device is connected to the control unit, and a cathode of the second switching device is connected to a condenser and the vehicle control system.

6. The electronic control unit as claimed in claim 4, wherein the first switching device is a P-type power semiconductor device and the second switching device is an N-type power semiconductor device.

7. A method for controlling a vehicle in which an electronic control unit is mounted to the vehicle and the vehicle operates with a system driving voltage of the electronic control unit regardless of a voltage level of a vehicle power system of the vehicle through a voltage conversion by the electronic control unit, the method comprising:
receiving an input of an input voltage from the vehicle power system of the vehicle;
comparing the input voltage with a predetermined system driving voltage;
determining a step up condition to output a step up control signal when the input voltage is lower than the system driving voltage, and determining a step down condition to output a step down control signal when the input voltage is higher than the system driving voltage;
boosting the input voltage to the system driving voltage according to the step up control signal, and dropping the input voltage to the system driving voltage according to the step down control signal; and
performing a vehicle control function by receiving the input voltage boosted to the system driving voltage or the input voltage dropped to the system driving voltage to operate with the system driving voltage.
